(19) United States
(12) Patent Application Publication
(10) Pub. No.: US 2025/0269491 A1
(43) Pub. Date: Aug. 28, 2025

(54) TOOL SPINDLE AND MACHINE TOOL COMPRISING A TOOL SPINDLE

(71) Applicant: Urs TSCHUDIN, Grenchen (CH)

(72) Inventor: Urs TSCHUDIN, Grenchen (CH)

(21) Appl. No.: 19/059,983

(22) Filed: Feb. 21, 2025

(30) Foreign Application Priority Data
Feb. 22, 2024 (EP) 24159226.0

(51) Int. Cl. B24B 41/04

(52) U.S. Cl. CPC B24B 41/04

(57) ABSTRACT

A tool spindle (1), comprising: a spindle shaft (3), which extends along a spindle axis (3a) and to which a tool can be coupled in a rotationally fixed manner at a tool interface (31); a spindle housing (2), which receives the spindle shaft (3); a drive device (4), which is coupled to a coupling section (33) of the spindle shaft (3) for rotationally driving, a bearing device (4), which supports the spindle shaft (3) in the spindle housing (2), wherein the spindle shaft (3), and preferably the spindle housing (2), is made of a material, which has, at least in one direction, a heat expansion coefficient of essentially zero. To ensure high precision requirements, the bearing device (4) has a first tool interface-side fixed bearing section (4a) and a second coupling section-side fixed bearing section (4b), wherein the bearing device (4) is arranged along the spindle axis (3a) between tool interface (31) and coupling section (3) and supports the spindle shaft exclusively.

### CROSS-REFERENCE TO RELATED APPLICATIONS

This application claims priority based on European Patent Application No. 24159226.0 filed Feb. 22, 2024.

The present invention relates to a tool spindle and a machine tool comprising a tool spindle.

A tool spindle is already known from the CH 715 948 A2, which comprises a spindle shaft, which can be coupled to a tool. The spindle shaft can be driven by means of a drive device. A bearing device supports the spindle shaft in a spindle housing. It is further proposed that the spindle shaft has a thermal expansion coefficient of close to zero. The bearing device has two fixed bearing sections.

In the CH 715 948 A2, however, the fixed bearing sections are provided on both sides of the drive device.

However, the problem in the prior art is that a relatively large distance exists between a load application point by the tool and the fixed bearing section, which is away from said load application point. This can lead to relatively large deformations, which do not meet highly precise requirements. In addition, the tool spindle as a whole becomes relatively long and the weight thus becomes relatively high. The precision is thus also affected thereby. The known tool spindle cannot be suitable for high-precision applications, such as grinding machines, in particular those for centerless cylindrical grinding.

It is thus an object of the present invention to provide a highly precise and compact tool spindle, which is suitable in particular for a grinding machine, furthermore particularly for centerless cylindrical grinding.

The above object is solved by means of a tool spindle, which has the features according to claim 1.

According to a first aspect, a tool spindle, preferably for grinding machines, even more preferably for centerless grinding machines, is provided, which comprises: a spindle shaft, which extends along a spindle axis and to which a tool can be coupled in a rotationally fixed manner at a tool interface; a spindle housing, which receives the spindle shaft; a drive device, which is coupled to a coupling section of the spindle shaft for rotationally driving, a bearing device, which supports the spindle shaft in the spindle housing, wherein the spindle shaft, and preferably the spindle housing, is made of a material, which has, at least in one direction, a heat expansion coefficient in a range with a lower limit of [−10*10⁻⁶/K, −5*10⁻⁶/K and −2*10⁻⁶/K] and an upper limit of [+2*10⁻⁶/K, +5*10⁻⁶/K and +10*10⁻⁶/K], in particular essentially zero.

In particular differing from the prior art, the present invention is characterized in that the bearing device has a first tool interface-side fixed bearing section and a second coupling section-side fixed bearing section, wherein the bearing device is arranged along the spindle axis between tool interface and coupling section and supports the spindle shaft exclusively.

The tool interface-side fixed bearing section and the coupling section-side fixed bearing section are thus arranged on one side of the coupling section, namely on the side of the tool interface. A distance between the two fixed bearing sections can thus be reduced. The length along of the spindle axis of the tool spindle can be reduced thereby, whereby weight can be saved. Absolute deformations in the radial as well as in the axial direction as well as deflections due to the smaller free length between the fixed bearing sections can furthermore be reduced, preferably eliminated completely, at least between the fixed bearing sections, even if high radial and/or axial loads must be absorbed under certain circumstances. The two fixed bearing sections can furthermore prevent a transfer of vibrations occurring at the coupling section. The tool spindle according to the invention can thus be used for high-precision applications, in particular for centerless grinding.

By definition, it is to be noted that a fixed bearing section can take up radial and axial loads respectively in opposite directions, can thus carry them to the spindle housing.

Each fixed bearing section can comprise at least one rolling bearing, or can be formed by at least one rolling bearing.

In particular, according to the invention, an interaction can exist between the low heat expansion coefficient and the bearing device. This is so because the heat expansion coefficient close to zero promotes the provision of two fixed bearing sections on one side of the coupling section because the low heat expansion increases the design freedom for the arrangement of the fixed bearing sections. Due to the low heat expansion coefficient, the fixed bearing sections can be arranged with a small bearing distance, wherein absolute deformations can be kept small in the event of occurring heat expansions.

It is to be noted that each range, which is obtained by the combination of each specified lower limit of the heat expansion coefficient with each upper limit, is comprised by this invention. However, symmetrical ranges, such as [−10*10⁻⁶/K; +10*10⁻⁶/K], [−5*10⁻⁶/K; +5*10⁻⁶/K] and [−2*10⁻⁶/K; +2*10⁻⁶/K] are particularly preferred.

Spindle housing and spindle shaft can be formed of the same material.

A minimum distance between the first fixed bearing section and the second fixed bearing section along the spindle axis is preferably equal to or larger than a maximum diameter of the spindle shaft in a region, which is supported by the first and second fixed bearing section.

The stiffness of the spindle shaft support can thus be increased because a sufficient distance between the fixed bearing sections can be ensured. This is in particular advantageous because loads can also be introduced at the coupling section by means of the drive devices. In particular, a sufficient stiffness can be ensured with regard to the maximal diameter occurring in the region between the fixed bearing sections.

The at least one direction of the heat expansion is preferably a radial direction of the spindle shaft, and even more preferably also a direction along the spindle axis.

A circumference of the tool, which can be coupled to the tool shaft, can thus be positioned with the highest precision, and high loads acting on the circumference can be absorbed. This is advantageous in particular in the case of centerless cylindrical grinding machines, in the case of which particularly high loads act along the circumference. If a direction along the spindle axis is additionally free from heat expansion, a shifting of a workpiece in the axial direction can be prevented, and an even removal at the workpiece can be ensured.

According to a further aspect, at least the first fixed bearing section can comprise a multi-row bearing.

The bearing stiffness can thus be increased on the side of the tool interface. The precision of the tool guidance can thus be increased further. Alternatively or additionally, the second fixed bearing section can comprise a multi-row bearing. In this disclosure, a multi-row bearing comprises each arrangement, in which a plurality of rolling bodies are arranged next to one another in the axial direction. This thus refers to multi-row bearings with only one inner bearing race and outer bearing race, but also to bearings arranged directly one behind the other in the axial direction, each with an inner bearing race and outer bearing race, which touch one another in the axial direction.

According to yet a further aspect, at least one of the first and the second fixed bearing section can be prestressed.

A bearing play can thus be suppressed, and the precision can be further increased. The bearing stiffness can furthermore be increased.

According to yet a further aspect, at least the first bearing section can comprise an angular contact bearing.

According to this aspect, relatively high combined radial and axial loads can be absorbed. In addition, the vibration sensitivity can be reduced. As a whole, the precision, in particular the concentricity accuracy, can be increased therewith.

The first fixed bearing section and the second fixed bearing section preferably define an O-arrangement.

Respective virtual bearing points along the spindle axis can thus be shifted close to the tool interface by means of the first fixed bearing section and close to the coupling section by means of the second fixed bearing section. The precision can thus be increased additionally.

The spindle shaft is preferably formed as hollow shaft.

The weight can thus be reduced and a necessary bending stiffness can be ensured at the same time, As a consequence, a precision of a machine tool can be increased by means of the reduced weight, when the tool spindle is attached to a machine frame.

According to yet a further aspect, the coupling section can be located further radially inwards than the first and second fixed bearing section.

The stiffness of the support can be increased thereby by means of the first and second fixed bearing section. An excessive protrusion of the drive device, which is coupled to the coupling section, into the radial direction can additionally be suppressed. The compactness of the tool spindle can thus be ensured.

According to yet a further aspect, the drive device can be a rotating electric machine.

The spindle shaft can be driven precisely thereby. In particular the start-up behavior, the acceleration and braking of the spindle shaft can be controlled precisely by means of the rotating electric machine. This is particularly advantageous because the rotating mass can be reduced due to the compactness of the spindle shaft.

According to yet a further aspect, the drive device can be arranged coaxially to the spindle axis.

An excessive protrusion of the drive device into the radial direction can thus be prevented. This promotes the compactness of the tool spindle.

A rotor of a rotating electric machine can in particular be arranged directly and coaxially on the spindle shaft. The rotor can thus move integrally with the spindle shaft.

It is furthermore advantageous when the drive device is coupled directly, thus without an interposed transmission, to the coupling section.

The material of the spindle shaft and/or of the spindle housing preferably has carbon fiber reinforced plastic (CFRP), in particular with different winding directions, is even more preferably formed therefrom.

The low heat expansion coefficient of essentially zero can be ensured therewith. In addition, a high stiffness with relatively low weight can be ensured. The precision can thus be increased. Spindle housing and spindle shaft can be made of CFRP but can have different winding directions or laying directions, respectively.

The CFRP material can be formed from a unidirectional carbon fiber reinforced plastic material, in the case of which the fibers extend parallel to the spindle axis. It can also be made of a weave with two preferred directions of the fibers perpendicular to one another, such as, for example, plain weave or twill weave. In addition, the spindle shaft can have at least two differently oriented unidirectional layers, which are offset in terms of amount by the same angle, preferably 45°, relative to the spindle axis, but in opposite directions. The material structure can be symmetrical in the radial direction. With regard to a radial heat expansion coefficient close to zero, the fibers can also have a component in the radial and axial direction, the fibers can preferably be inclined at an angle of, for example, 45° with respect to a radial and axial direction, even more preferably at least two in respective different directions, which can correspond to a type of double helix.

The CFRP material can furthermore be produced in the preforming process. The CFRP material can include short fibers, long fibers or continuous fibers.

According to yet a further aspect, the tool spindle can furthermore comprise a, preferably fluid-operated, cooling device, which is designed to cool the first and/or second fixed bearing section and/or the drive device and/or a section of the spindle housing between coupling section and the second fixed bearing section.

An excessive heat development can thus be prevented. A deformation can thus be reduced, preferably completely eliminated, even in sections with a heat expansion coefficient deviating from zero. A fluid-operated cooling device can be established easily.

The first and/or second fixed bearing section is preferably cooled in a gaseous manner, preferably air-cooled, and/or the drive device is liquid-cooled, preferably water-cooled.

The cooling of the fixed bearing sections can thus be simplified and can be embodied in a compact manner. In addition, a relatively large cooling performance can be provided to the drive device.

According to yet a further aspect, the tool spindle can comprise a fastening section, which can be attached to a machine frame and which is coupled to the spindle housing.

The tool spindle can thus be provided as separate element, which can be releasably fastened to a machine frame. The fastening section can be a flange, for example.

A further aspect provides a machine tool, preferably grinding machine, particularly preferably a centerless grinding machine, which comprises: a machine frame; and a tool spindle according to at least one of the preceding aspects, which is fastened to the machine frame.

The above aspects can thus be attained in the case of the machine tool.

The machine frame is preferably likewise formed at least in sections, preferably completely, from a material with a heat expansion coefficient in a range with a lower limit of [−10*10⁻⁶/K, −5*10⁻⁶/K and −2*10⁻⁶/K] and an upper limit of [+2*10⁻⁶/K, +5*10⁻⁶/K and +10*10⁻⁶/K], in particular of essentially zero.

A compatibility with respect to the heat expansion coefficient can thus be established between tool spindle and machine frame. The occurrence of restraint stresses can thus be avoided. Every combination of lower and upper limit is also conceivable for the machine frame, whereby symmetrical ranges are preferred.

Alternatively or additionally, the material of the spindle shaft can have a lower heat expansion coefficient than that of the material of the machine frame.

The material of the machine frame can be determined here at the attachment section of the machine frame for the fastening section of the spindle housing.

A high concentricity precision of the spindle shaft can be ensured thereby even in the case of a higher heat expansion coefficient of the machine frame.

Alternatively or additionally, the material of the machine frame can be non-metallic, particularly, can have stone, in particular granite, at least in sections, preferably completely, can preferably be formed therefrom.

A robust machine frame with low heat expansion coefficient can thus be attained. This material selection can take place in particular at an attachment section of the machine frame for the fastening section of the spindle housing.

A further aspect of the invention relates to a use of the tool spindle according to one of the above aspects for a grinding machine, in particular a grinding machine for centerless grinding.

The present invention will be described in detail below with reference to the enclosed drawings.

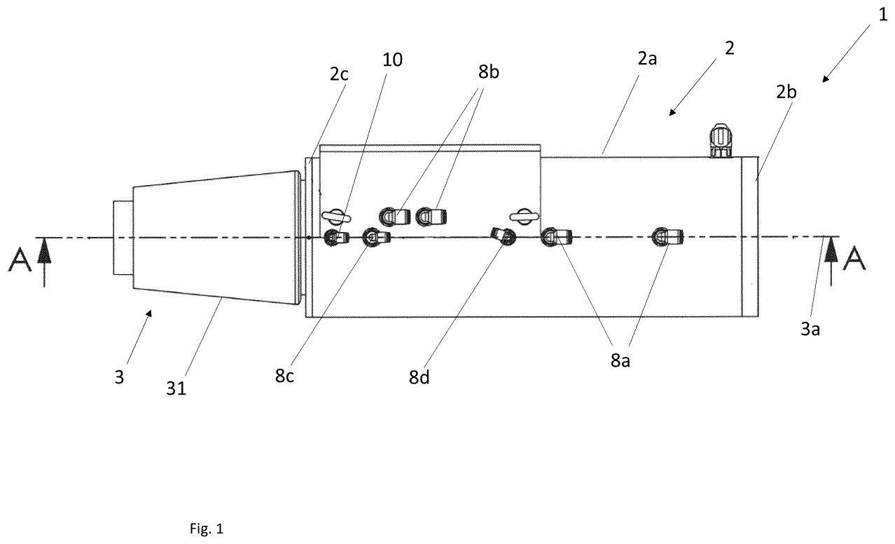

FIG. 1 shows a top view onto a tool spindle according to the invention.

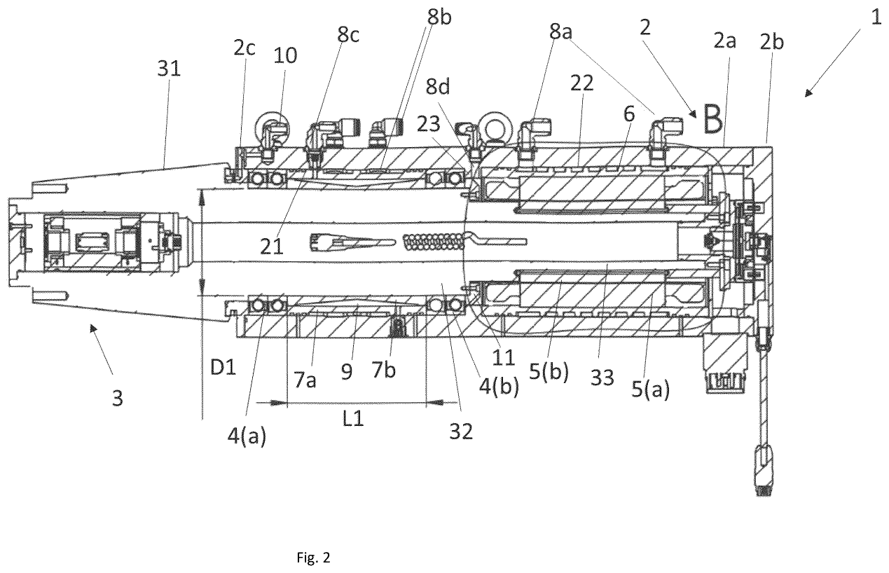

FIG. 2 shows a section along a line A-A in FIG. 1

A tool spindle 1 is illustrated in FIG. 1. The tool spindle 1 can be fastened, for example, to a machine frame, such as a granite block, of a grinding machine as example of a machine tool. The tool spindle 1 can in particular be used for cylindrical grinding, furthermore in particular for centerless cylindrical grinding.

As essential components, the tool spindle 1 has a spindle housing 2 and a spindle shaft 3, which extends along a spindle axis 3a, which defines an axial direction.

The spindle housing 2 has a main body 2a and a cover 2b. The main body 2a can be formed integrally, in particular monolithically, as one element. The spindle housing 2, but at least the main body 2a thereof, can be made of the same material as the spindle shaft 3.

The main body 2a extends essentially along the spindle axis. The main body 2a is a hollow cylindrical element, as can be seen in FIG. 2, with a circular cross section and essentially constant outer diameter along the spindle axis.

The spindle housing 2 defines two receiving chambers in the axial direction, namely a bearing receiving chamber 21 and a drive receiving chamber 22, which are separated by means of a protrusion 23 protruding inwards, but which can be omitted. The two receiving chambers each have an essentially constant circular inner diameter. The respective inner diameters of the receiving chambers 21 and 22 are preferably the same size.

A bearing device 4 is arranged in the bearing receiving chamber 21. In the radial direction, the bearing device 4 is located between spindle housing 2 and spindle shaft 3.

The drive receiving chamber 22 receives a drive device 5. The drive device 5 is a rotating electric machine here, in particular an electric motor. It can be a direct or alternating current motor. In particular, an asynchronous motor can be provided as the drive device 5.

In the radial direction, the drive device 5 is located between spindle housing 2 and spindle shaft 3. The drive device has a stator 5a and a rotor 5b. The stator 5a is fixed to the inner side of the spindle housing 2, whereby a cooling sleeve 6 is interposed.

The rotor 5b can have a rotor carrier and rotor windings on the rotor carrier. The rotor 5b is attached to the spindle shaft 3 so that it can rotate integrally with the latter.

The spindle shaft 3 is formed as a rotationally symmetrical hollow shaft. Along the spindle axis 3a from the left to the right in FIG. 2, it has a tool interface section (tool interface in terms of the claims) 31, a bearing section 32, and a coupling section 33.

The tool interface section 31 widens conically in the axial direction towards the coupling section 33. In the axial direction, the outer diameter D1 of the bearing section 32 is uniform and smaller than the minimum outer diameter of the tool interface section 31.

Lastly, the outer diameter of the coupling section 33 is essentially also uniform in the axial direction and, in turn, smaller than the diameter D1 of the bearing section 32.

The bearing device 4 is arranged on the outer circumference of the bearing section 32 with uniform outer diameter.

The bearing device 4 is arranged between tool interface section 31 and coupling section 33 and has a first fixed bearing section 4a on the side of the tool interface section 31 and a second fixed bearing section 4b on the side of the coupling section 33.

The first fixed bearing section 4a has two identical rolling bearings here, namely angular contact roller bearings. They are arranged axially directly adjacent to one another. The pressure line of the angular contact roller bearings runs in the direction of the spindle axis to the tool interface section 31.

The second fixed bearing section 4b has two identical rolling bearings here, namely angular contact roller bearings. They are arranged axially directly adjacent to one another. The pressure line of the angular contact roller bearings runs in the direction of the spindle axis to the coupling section 33. The first and second fixed bearing section thus define an O-arrangement. An outer ring of the fixed bearing section 4b rests against the protrusion 23, which separates the two receiving chambers 21 and 22 of the same diameter.

The minimum axial distance L1 between the two fixed bearing sections 4a and 4b is set by two spacer sleeves 7a and 7b, which are radially spaced apart from one another. The radially outer spacer sleeve 7a is also a cooling sleeve.

A clamping sleeve 11, which is screwed axially by means of screws into a shaft shoulder between bearing section 32 and coupling section 33, prestresses the bearing device 4.

The rotor 5b is coupled directly to the coupling section 33 and is arranged coaxially thereto.

The tool spindle 1 furthermore has at least one cooling device.

A cooling device 8a is designed as water cooling and is arranged to cool the drive device 5, in particular the stator 5a. It comprises the cooling sleeve 6, which has several circumferential grooves on its outer circumference, which are axially spaced apart from one another and connected to one another and in which the cooling fluid can flow. In addition, the cooling device 8a has connection openings in the spindle housing 2, which communicate with two of the circumferential grooves for the inflow and outflow of the cooling fluid, as well as connections for circulating the fluid, which are inserted into the connection openings.

A cooling device 8b is designed similarly and is arranged to cool the bearing device 4, thus first and second fixed bearing sections. It is also designed in a liquid-cooling manner and comprises the cooling sleeve 7a, which has several circumferential grooves on its outer circumference, which are axially spaced apart from one another and connected to one another and in which the cooling fluid can flow. Connection openings are also provided in the spindle housing 2 here, which communicate with the circumferential grooves. Connections for circulating the fluid into the connection openings are furthermore provided.

A further cooling device 8c is designed for the gaseous cooling of the bearing section 4, in particular with air. It comprises an air circulation chamber 9 in the radial direction between the sleeves 7a and 7b. Connection openings through the spindle housing 2 and the cooling sleeve 7a communicate with the air circulation chamber 9. Connections can be inserted in the connection openings.

Yet a further cooling device 8d is designed for the gaseous cooling, in particular with air, and comprises at least one opening in the spindle housing 2 through the protrusion 23, thus a section of the housing in the axial direction between coupling section 33 and second fixed bearing section 4b, or between drive device 5 and bearing device 4. The cooling fluid can be supplied via a connection through this opening.

A further cover 2c is provided on an axially opposite side of the cover 2b and forms a stop for the outer race of the first fixed bearing section 4a. The cover 2b closes a coupling-side end section of the main body 2a, and the cover 2c closes a tool-side end section of the main body 2a.

An air-barrier sealing device 10 is provided for sealing between cover 2c and spindle shaft 3.

According to the invention, the spindle shaft 3 is made completely of a material, which has, at least in one direction, a heat expansion coefficient in a range with a lower limit of [−10*10⁻⁶/K, −5*10⁻⁶/K and −2*10⁻⁶/K] and an upper limit of [+2*10⁻⁶/K, +5*10⁻⁶/K and +10*10⁻⁶/K], for example in a range [−2*10⁻⁶/K; +2*10⁻⁶/K]. For example, the spindle shaft can be made of CFRP. The spindle housing 2 can be made of the same material. Winding directions of the CFRP fibers can be identical or can differ from one another.

For example, the spindle shaft 3 can have at least two layers with different laying direction/winding direction, whereby the laying angle can be the same in terms of amount with respect to the spindle axis 3a and the radial direction, but can point in opposite directions.

Functions and effects of the invention will be described below.

Relatively large grinding disks with diameters of up to 500 mm are used as tools, for example in the case of the centerless cylindrical grinding. The grinding disk can be attached to the conical tool interface section 31, for example via a conical tool holder. The tool can be clamped to the tool interface section 31 via a flange section of the spindle shaft 3, into which a clamping sleeve can be screwed, on a side of the tool interface section 31 facing away from the coupling section 33.

The spindle shaft 3 has to provide the necessary rotational speed of up to 6,000 revolutions per minute. Together with the large diameter of the grinding disk, a significant heat development can occur here. In order to nonetheless ensure a high precision, in particular concentricity characteristic, the spindle shaft 3 and additionally the spindle housing 2 is made of a material with a heat expansion coefficient of essentially zero. Heat-induced stresses can additionally be avoided.

By means of the arrangement of the bearing device 4 between tool interface and coupling section 33 of the spindle shaft, thus on one side of the coupling section 33 and of the drive device 5 in the axial direction, the resulting deformations can be kept small. The axial length can also be reduced. The precision can thus be increased.

The length L1 is larger than the diameter D1 of the bearing section 31, thus the region, which is supported by the bearing device. A sufficient stiffness with respect to the diameter D1 can thus be ensured, and loads due to the drive device 5 can also be absorbed.

The material of the spindle shaft 3 and/or of the spindle housing 2 can be essentially isotropic with respect to the heat expansion coefficient, but the heat expansion coefficient is zero at least essentially in the radial direction. A high concentricity accuracy can thus be attained.

The bearing device 4 is a prestressed O-arrangement. In addition, the fixed bearing sections 4a and 4b are each multi-row bearings, here two adjacent angular contact roller bearings. The bearing stiffness can thus be increased and high process forces can be absorbed. It is to be noted that in this example the two single-row bearings, which are directly adjacent to one another in the axial direction, in each case form the multi-row bearing. The two adjacent bearings are each arranged in an O-arrangement, thus a tandem O-arrangement.

The coupling section 33 is located further radially inwards than the bearing section 31, thus than the inner diameter of the fixed bearing sections 4a and 4b. Space can thus be created radially for the drive device. In addition, the individual bearings can simply be attached to the spindle shaft 3 from the side of the coupling section 33. This is particularly advantageous when the first 4a and second fixed bearing section 4b have the same inner diameter.

The coaxial arrangement of the rotating electric machine as drive device 5 with the spindle shaft furthermore provides space savings.

The cooling devices 8a to 8d provide for a reduction of the heat development. Even the bearing device, which can be made of a different material than that of the spindle shaft and of the spindle housing, in particular with a higher heat expansion coefficient, can thus be protected against deformation.

The spindle shaft 3 is formed as hollow shaft. The weight can thus be reduced. Further components can additionally be received in the interior space of the hollow shaft. For example, a balancing device with at least one balancing weight can be provided in the interior space of the spindle shaft 33 at an end section of the spindle shaft on the side of the coupling section 33.

The spindle housing 2 can include a non-illustrated fastening section, such as a flange. The latter can be provided, for example, at a central section of the spindle housing in the axial direction and can protrude radially outwards from the main body 2a. The tool spindle 1 can be fastened with this fastening section to a machine frame, for example of granite. For this purpose, several screws can be provided in through bores along the circumference of the fastening section.

At least in sections, the machine frame can have a material, which has a higher heat expansion coefficient than that of the spindle shaft material.

Modifications of the embodiment will now be described.

The material of the spindle shaft and/or of the spindle housing can be different from CFRP. For example, aramid fiber-reinforced plastic can be used for at least one of the spindle shaft and of the spindle housing.

At least one of the fixed bearing sections cannot comprise an angular contact bearing. Bearings other than ball bearings can also be used. For example, a tapered roller bearing can be used for at least one of the fixed bearing sections.

The tool spindle can also be used for other machine tools, for example milling machines.

The spindle housing can also be formed in several parts. The main body can thus comprise several parts.

The fixed bearing sections can also have different inner diameters and the bearing section can thus have different outer diameters.

A gear can be provided between drive device and coupling device.

The protrusion 23 can be omitted. The inner diameter of the drive receiving chamber 22 can be larger than that of the bearing receiving chamber 21.

1. A tool spindle (1), preferably for grinding machines, even more preferably for centerless grinding machines, comprising:
a spindle shaft (3), which extends along a spindle axis (3a) and to which a tool can be coupled in a rotationally fixed manner at a tool interface (31);
a spindle housing (2), which receives the spindle shaft (3);
a drive device (4), which is coupled to a coupling section (33) of the spindle shaft (3) for rotationally driving,
a bearing device (4), which supports the spindle shaft (3) in the spindle housing (2),
wherein the spindle shaft (3), and preferably the spindle housing (2), is made of a material, which has, at least in one direction, a heat expansion coefficient in a range with a lower limit of [−10*10−6/K, −5*10−6/K and −2*10−6/K] and an upper limit of [+2*10−6/K, +5*10−6/K and +10*10−6/K], in particular essentially zero,
wherein the bearing device (4) has a first tool interface-side fixed bearing section (4a) and a second coupling section-side fixed bearing section (4b), wherein the bearing device (4) is arranged along the spindle axis (3a) between tool interface (31) and coupling section (3) and supports the spindle shaft exclusively.

2. The tool spindle (1) according to claim 1, wherein
a minimum distance (L1) between the first fixed bearing section (4a) and the second fixed bearing section (4b) along the spindle axis (3a) is equal to or larger than a maximum diameter (D1) of the spindle shaft (3) in a region, which is supported by the first (4a) and second fixed bearing section (4b).

3. The tool spindle (1) according to claim 1,
wherein the at least one direction of the heat expansion is a radial direction of the spindle shaft (3), and preferably also a direction along the spindle axis (3a).

4. The tool spindle (1) according to claim 1,
wherein at least the first fixed bearing section (4a) comprises a multi-row bearing.

5. The tool spindle (1) according to claim 1, wherein
at least one of the first (4a) and the second fixed bearing section (4b) is prestressed.

6. The tool spindle (1) according to claim 1, wherein at least the first fixed bearing section (4a) comprises an angular contact bearing.

7. The tool spindle (1) according to claim 6, wherein the first fixed bearing section (4a) and the second fixed bearing section (4b) define an O-arrangement.

8. The tool spindle (1) according to claim 1, wherein the spindle shaft (3) is formed as hollow shaft.

9. The tool spindle (1) according to claim 1, wherein
the coupling section (33) is located further radially inwards than the first (4a) and second fixed bearing section (4b).

10. The tool spindle (1) according to claim 1, wherein
the drive device (5) is a rotating electric machine.

11. The tool spindle (1) according to claim 1,
wherein the drive device (5) is arranged coaxially to the spindle axis (3a).

12. The tool spindle (1) according to claim 1, wherein
the material of the spindle shaft (3) and/or of the spindle housing (2) has carbon fiber reinforced plastic, in particular with different winding directions, is preferably formed therefrom.

13. The tool spindle (1) according to claim 1, furthermore comprising a, preferably fluid-operated, cooling device (8a, 8b, 8c, 8d), which is designed to cool the first (4a) and/or second fixed bearing section (4b) and/or the drive device (5) and/or a section of the spindle housing (2) between coupling section (33) and the second fixed bearing section (4b).

14. The tool spindle (1) according to claim 13, wherein
the first (4a) and/or second fixed bearing section (4b) is cooled in a gaseous manner, preferably air-cooled, and/or
the drive device (5) is liquid-cooled, preferably water-cooled.

15. The tool spindle (1) according to claim 1, furthermore comprising a fastening section, which can be attached to a machine frame and which is coupled to the spindle housing (2).

16. A machine tool, preferably grinding machine, comprising:
a machine frame; and
a tool spindle (2) according to claim 1, which is fastened to the machine frame, wherein, preferably,
the machine frame is likewise formed at least in sections from a material with a heat expansion coefficient in a range with a lower limit of [−10*10−6/K, −5*10−6/K and −2*10−6/K] and an upper limit of [+2*10−6/K, +5*10−6/K and +10*10−6/K], in particular of essentially zero and/or
the material of the spindle shaft (2) has a lower heat expansion coefficient than that of the material of the machine frame, and/or
the material of the machine frame is non-metallic, particularly, has stone, more particularly granite, at least in sections, preferably completely, is preferably formed therefrom.
